(19) United States
(12) Patent Application Publication
(10) Pub. No.: US 2013/0257193 A1
(43) Pub. Date: Oct. 3, 2013

(54) DRIVE APPARATUS AND METHOD FOR MANUFACTURING THE SAME

(71) Applicant: DENSO CORPORATION, Kariya-city (JP)

(72) Inventors: Yasuyoshi TODA, Toyohashi-city (JP); Hiroyuki KAWATA, Chiryu-city (JP)

(73) Assignee: DENSO CORPORATION, Kariya-city (JP)

(21) Appl. No.: 13/853,469

(22) Filed: Mar. 29, 2013

(30) Foreign Application Priority Data
Mar. 29, 2012 (JP) 2012-76142

(51) Int. Cl. H02K 5/10; H02K 5/22; H02K 15/00; H02K 9/22

(52) U.S. Cl. CPC H02K 5/10; H02K 9/22; H02K 5/225; H02K 15/00
USPC 310/52; 29/596

(57) ABSTRACT

A motor drive apparatus includes a heat sink, on which a power module is disposed. A control circuit board and a power circuit board are disposed on axially opposite sides of the heat sink. A component carrier is disposed close to the power circuit board at a side opposite to an output part of a motor case. An electric connector is extended from the component carrier, passed through a hole of a cover and extended to an outside opposite to the output part. Even in a case where a mounting space is limited in a radial direction of the motor case, the electric connector can be easily connected to an external connector of a vehicle.

### CROSS REFERENCE TO RELATED APPLICATION

This application is based on and incorporates herein by reference Japanese patent application No. 2012-76142 filed on Mar. 29, 2012.

### TECHNICAL FIELD

The present disclosure relates to a motor drive apparatus, in which a motor is integrated with an electronic control unit and a method for manufacturing the same.

### BACKGROUND

A conventional electric power steering system (EPS) assists a steering operation of a driver by driving force of a motor.

JP 2011-176998A (US 2012/0098361A1) discloses one exemplary motor drive apparatus applied to an EPS. The motor drive apparatus supplies torque to a speed reduction gear disposed on a column shaft coupled to a steering wheel of a vehicle to thereby assist a steering operation. In the motor drive apparatus, a connector disposed in a direction perpendicular to a motor shaft is connected to an external connector provided in the vehicle. An electronic control unit of the motor drive apparatus is supplied with electric current and a signal for driving the motor from the external connector provided in the vehicle via the connector of the motor drive apparatus.

The motor drive apparatus of the EPS is fixed to a rack for connecting left and right driving wheels of the vehicle in some cases. In this case, an engine is mounted above the rack, so that a space in which the motor drive apparatus is located is limited. For this reason, in the motor drive apparatus, a motor shaft is fixed parallel to a shaft of the rack.

The motor drive apparatus has a connector disposed in a direction perpendicular to a motor shaft. Hence, when the motor drive apparatus is fixed to the rack, it is difficult to connect the connector of the motor drive apparatus to the external connector of the vehicle.

Further, an engine compartment of a vehicle, in which the rack is arranged, is exposed to rain. Hence, when the motor drive apparatus is fixed to the rack, water or a foreign matter is likely to enter into a cover of the electronic control unit from a clearance between the cover and the connector.

### SUMMARY

It is therefore an object to provide a motor drive apparatus, in which a connector is arranged on a side opposite to an output part of a motor, and a method for manufacturing the motor drive apparatus.

According to one aspect, a motor drive apparatus has a control circuit board arranged on an output part side in a motor shaft direction of a motor across a heat sink, and a power circuit board arranged on a side opposite to the output part. The motor drive apparatus includes a connector extended from a component carrier and passed through a hole of a cover and extended to a side opposite to the output part.

In this way, in the motor drive apparatus having a motor control unit which is small in dimension in a radial direction, the connector is disposed on the side opposite to the output part of the motor. For this reason, even in the case where a space, in which the motor drive apparatus is located, is limited in the radial direction of the motor shaft of the motor, the connector of the motor drive apparatus can be easily connected to an external connector of a vehicle. Hence, mounting work of the motor drive apparatus in the vehicle can be simplified.

A method for manufacturing a motor drive apparatus includes a first mounting step of inserting one end of a signal wiring into a connector board from a side of the connector and soldering the connector board and the signal wiring in a state where the signal wiring is raised perpendicularly with respect to the connector board, a bending step of bending the signal wiring to a side of the control circuit board, and a second mounting step of mounting the other end of the signal wiring on the control circuit board.

In this way, the signal wire can be easily mounted on the connector board and the control circuit board. Hence, a manufacturing cost can be reduced.

### BRIEF DESCRIPTION OF THE DRAWINGS

The above and other objects, features and advantages will become more apparent from the following detailed description made with reference to the accompanying drawings. In the drawings:

FIG. 1 is a schematic view of an EPS, to which a motor drive apparatus according to a first embodiment is applied;

FIG. 2 is a wiring diagram of the motor drive apparatus according to the first embodiment;

FIG. 3 is an exploded view, in perspective, of the motor drive apparatus according to the first embodiment;

FIG. 4 is a side view of the motor drive apparatus according to the first embodiment;

FIG. 5 is a cross-sectional view taken on a line V-V in FIG. 4 and showing only an electronic control unit part;

FIG. 6 is a top plan view taken in a direction in an arrow VI in FIG. 5 and an upper half shows a view with a cover disposed and a lower half shows a view with the cover removed.

FIG. 7 is a schematic cross-sectional view of the motor drive apparatus according to the first embodiment;

FIG. 8 is a plan view of signal wires of the motor drive apparatus according to the first embodiment;

FIG. 9 illustrates a method of fixing the signal wire of the motor drive apparatus according to the first embodiment;

FIG. 10 illustrates the method of fixing the signal wire of the motor drive apparatus of the first embodiment;

FIG. 11 illustrates the method of fixing the signal wire of the motor drive apparatus of the first embodiment;

FIG. 12 is a schematic cross-sectional view of a section of a motor drive apparatus of a second embodiment; and

FIG. 13 is a plan view of signal wires of the motor drive apparatus of the second embodiment.

### DETAILED DESCRIPTION OF THE PREFERRED EMBODIMENTS

Hereinafter, a motor drive apparatus will be described in detail with reference to plural embodiments exemplarily shown in the drawings.

### First Embodiment

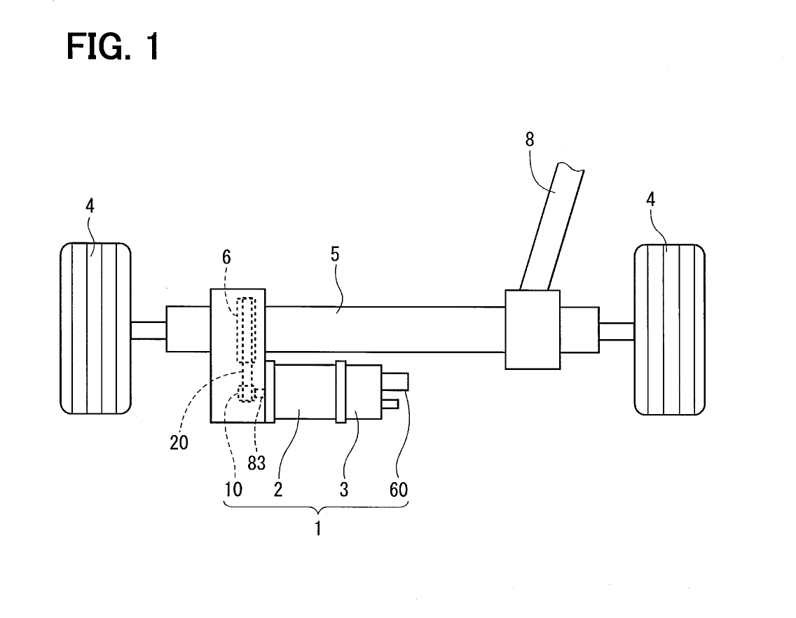

Referring first to FIG. 1, a motor drive apparatus 1 is applied to an electric power steering system (EPS) for assisting a steering operation of a driver by driving force of a motor unit 2. The motor drive apparatus 1 is constructed of the motor unit 2 and an electronic control unit (ECU) 3. The motor drive apparatus 1 is fixed to a rack 5 for connecting left and right tire wheels 4 of a vehicle in such a way that a motor shaft (rotary shaft) 83 of the motor drive apparatus 1 is parallel to a shaft of the rack 5. In the motor drive apparatus 1, an output part (output gear) of the motor shaft 83 of the motor unit 2 for outputting torque is coupled to a speed reduction gear 6 for moving the rack 5 in an axial or lateral (left and right) direction via a belt 20.

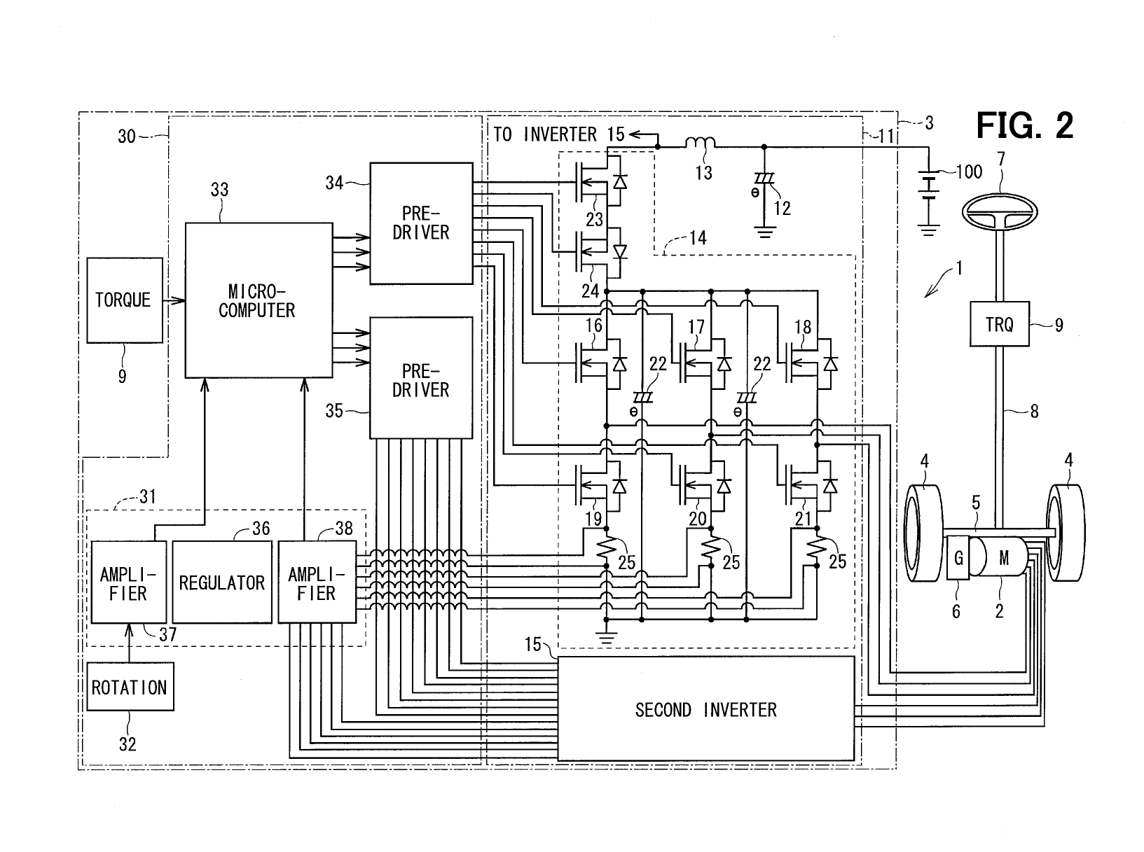

When a steering wheel 7 is operated by the driver, torque produced in a steering shaft 8 by the steering operation is detected by a torque sensor 9 (FIG. 2). The motor drive apparatus 1 produces torque for assisting the steering operation on the basis of a signal outputted from the torque sensor 9 and a vehicle speed signal transmitted from a CAN (control area network, not shown). This torque is transmitted to the rack 5 from the output part 10 of the motor drive apparatus 1 via the speed reduction gear 6 through the belt 20.

In the motor drive apparatus 1, an electric connector 60 disposed on a side opposite to the output part 10 has an external connector (not shown) of the vehicle connected thereto. An electric current and signals for driving the motor drive apparatus 1 are supplied to an electronic control unit 3 from the external connector of the vehicle via the electric connector 60 of the motor drive apparatus 1.

As shown in FIG. 2, the electronic control unit 3 is constructed of a power circuit 11, through which an electric current for driving the motor unit 2 flows, and a control circuit 30 for controlling an operation of the power circuit 11.

The power circuit 11 is constructed of a first capacitor 12, a choke coil 13 and two inverters 14 and 15. The inverter 14 is formed of a plurality of switching elements 16 to 21, a plurality of second capacitors 22, power relays 23, 24 and a plurality of shunt resistors 25. The inverter 15 also is formed similarly to the inverter 14.

The power circuit 11 has an electric power supplied thereto from a DC power source 100. The first capacitor 12 and the choke coil 13 provided in the power circuit 11 construct a filter circuit. Further, the choke coil 13 connected in series between the power source 100 and the power relays 23, 24 attenuates a voltage variation.

Since the inverters 14 and 15 have the same configuration, one inverter 14 will be described in detail below.

The power relays 23, 24 and the switching elements 16 to 21 are MOSFETs and are turned on or off between a source and a drain by a gate voltage. The power relays 23, 24 are interposed between the switching elements 16 to 21 and the choke coil 13 and interrupts current flowing to the motor unit 2 through the switching elements 16 to 21 at the time of abnormality.

Three switching elements 16 to 18 on a power source side has their drains connected to a power source side and has their sources connected to drains of three switching elements 19 to 21 on a ground side corresponding to the respective three switching elements 16 to 18 on the power source side. The sources of the three switching elements 19 to 21 on the ground side are connected to the ground via the shunt resistors 25. Connection points of the switching elements 16 to 18 on the power source side and the switching elements 19 to 21 on the ground side are connected to three-phase windings of the motor unit 2, respectively.

The shunt resistors 25 are connected between the switching elements 19 to 21 and the ground, respectively. By detecting voltage or current applied to the shut resistor 25, the current flowing through the motor unit 2 is detected.

The second capacitors 22 are connected to wiring on the power source side of the switching elements 16 to 21 and to wiring on the ground side. In short, the second capacitors 22 are connected in parallel to the switching elements 16 to 21, respectively. The second capacitors 22 store electric charges to thereby assist power supply to the switching elements 16 to 21 and absorb ripple current produced when the current is switched.

The control circuit 30 is constructed of a custom IC 31, a rotation angle sensor 32, a microcomputer 33, and pre-drivers 34 and 35.

The custom IC 31 is an integrated circuit including a regulator 36, a rotation angle sensor signal amplifier 37, and a detection voltage amplifier 38.

The regulator 36 is a stabilization circuit for stabilizing the electric power supplied from the power source 100. The microcomputer 33 is operable with a given voltage (for example, 5V) regulated by the regulator 36.

To the rotation angle sensor signal amplifier 37 is inputted a signal outputted from the rotation angle sensor 32. The rotation angle sensor 32 is disposed in a magnetic field of a magnet disposed on the moor shaft 83 of the motor unit 2 and detects a change in the magnetic field. A signal outputted by the rotation angle sensor 32 is transmitted to the rotation angle sensor signal amplifier 37 as a signal relating to a rotation angle of a rotor of the motor unit 2. The rotation angle sensor signal amplifier 37 amplifies the signal transmitted from the rotation angle sensor 32 and outputs the amplified signal to the microcomputer 33.

The detection voltage amplifier 38 detects voltage between both ends of the shunt resistor 25 and amplifies a detected value and outputs the amplified value to the microcomputer 33.

To the microcomputer 33 are inputted a signal of the rotation angle sensor signal amplifier 37, a signal of the detection voltage amplifier 38, a signal of the torque sensor 9, and vehicle speed information from the CAN.

When these signals are inputted to the microcomputer 33, the microcomputer 33 produces a pulse signal made by a PWM control via the pre-drivers 34 and 35 on the basis of the rotation angle of the rotor in such a way as to assist the steering operation of the steering wheel 7 according to the vehicle speed. The pulse signal controls a switching operation of turning on and off the switching elements 16 to 21 of the inverters 14, 15 of two systems. Further, the microcomputer 33 controls the inverters 14, 15 on the basis of the signal of the detection voltage amplifier 38 in such a way as to bring the current to be supplied to the motor unit 2 close to a sine wave. In this way, currents of sine waves having different phases are supplied to the motor unit 2, whereby a rotating magnetic field is produced in the windings of a stator of the motor unit 2. The motor unit 2 produces torque by the rotating magnetic field, whereby the steering operation by the driver can be assisted by the torque.

Next, the mechanical constructions of the motor unit 2 and the electronic control unit 3 will be described.

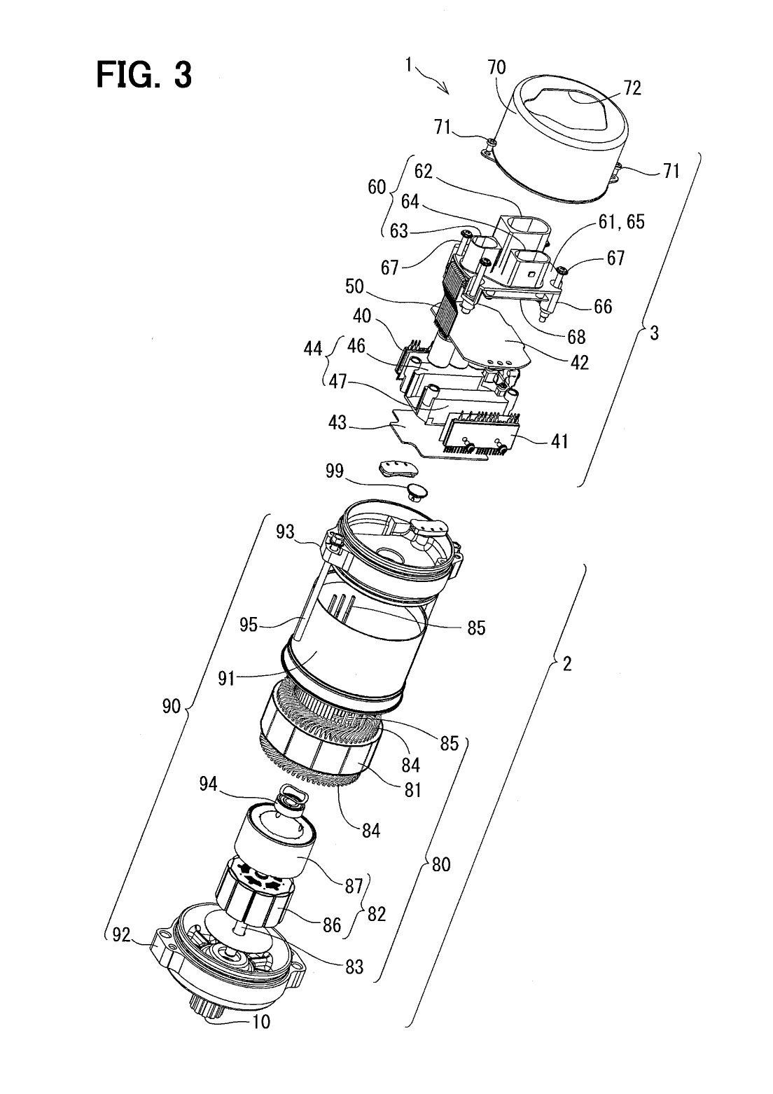

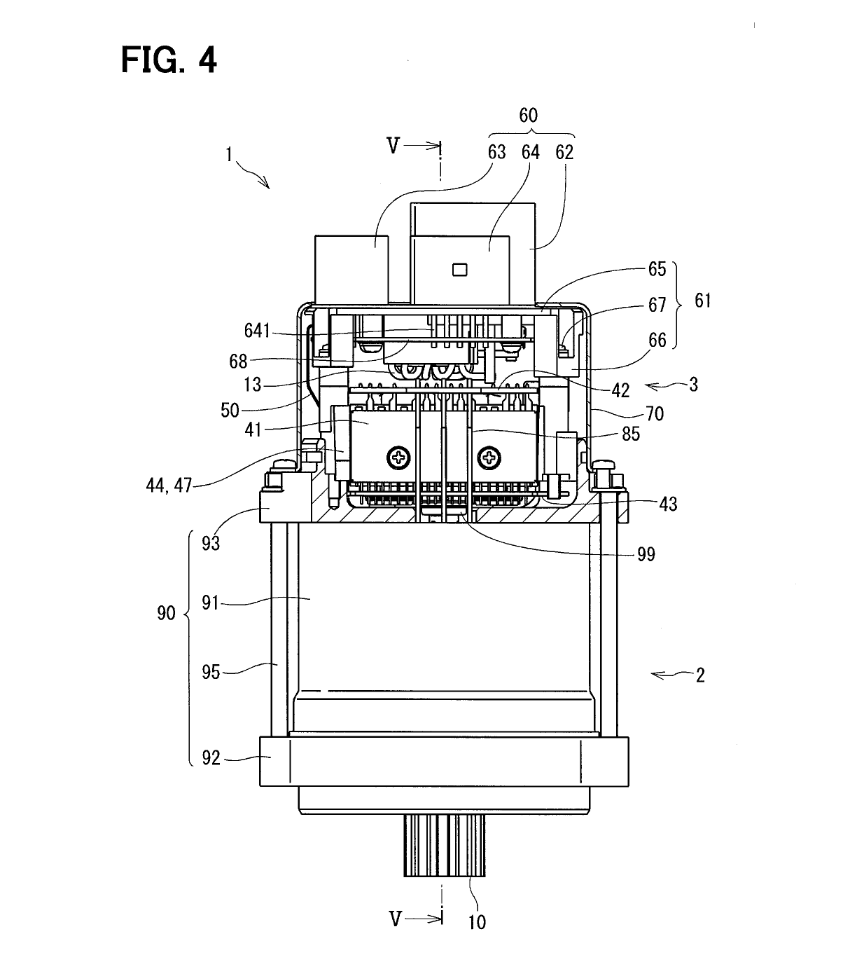

As shown in FIG. 3 and FIG. 4, the motor unit 2 has a motor 80, a motor case 90, and the output part 10. The motor 80 is constructed of a stator 81 and a rotor 82 including the motor shaft 83.

The stator 81 has salient poles and slots arranged alternately in a circumferential direction. Coils 84 are received in the slots of the stator 81. Each of the coils 84 is wound around each of the salient poles. The coils 84 form three-phase coil sets of two systems. Motor terminals 85 are led out from the coils 84, extended to the electronic control unit 3 side and connected to a power circuit board 42.

The rotor 82 is disposed in such a way as to rotate relatively to the stator 81 at a radially inside part of the stator 81. The rotor 82 is provided with a rotor core 86, which has different kinds of magnetic poles formed therein alternately in the circumferential direction, and a rotor case 87 for housing the rotor core 86.

The motor shaft 83 is fixed at a rotation center of the rotor 82. The motor shaft 83 has one end rotatably supported by a bearing (not shown) disposed at a front end frame 92 and has the other end rotatably supported by a bearing 94 disposed at a rear end frame 93. At an end portion on a control circuit board side of the motor shaft 83 is disposed a magnet 99 for detecting a rotation angle of the rotor 82.

The motor case 90 is constructed of a cylindrical motor case body 91, the front end frame 92 and the rear end frame 93. The stator 81 is fixed inside in the radial direction of the motor case body 91. The motor case body 91 has one axial end fitted in the front end frame 92 via an O ring (not shown) and has the other axial end fitted in the rear end frame 93. The front end frame 92 and the rear end frame 93 are fixed by through bolts 95 with the motor case body 91 interposed between them.

When current is passed through the coils 84 of the stator 81 from the switching elements 16 to 21 via the motor terminals 85, a rotating magnetic field is formed and the rotor 82 and the motor shaft 83 are rotated normally or reversely with respect to the stator 81. Torque is outputted to the speed reduction gear 6 of the rack 5 from the output part 10 disposed at a front end frame side of the motor shaft 83 via the belt 20.

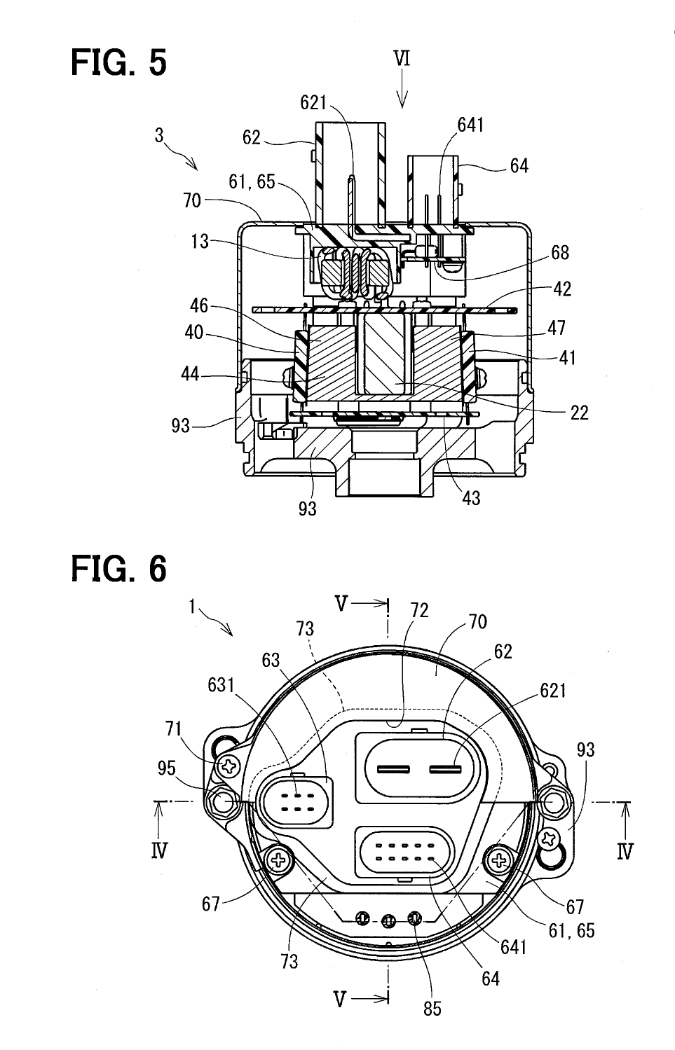

As shown in FIG. 3 to FIG. 7, the electronic control unit 3 includes a heat sink 44, a control circuit board 43, a power circuit board 42, the electric connector 60, a component carrier 61, and a cover 70.

The heat sink 44 is formed of metal having a high thermal conductivity, for example, aluminum and is fixed to the rear end frame 93 at a side opposite to the output part 10. The heat sink 44 has two side wall parts 46, 47 disposed symmetrically across the motor shaft 83 of the motor 80. One power module 40 is fixed to an outer wall of one wall part 46 and the other power module 41 is fixed to an outer wall of the other wall part 47. The heat sink 44 can absorb heat generated by the two power modules 40 and 41.

One power module 40 is constructed by the power supply relays 23, 24, the switching elements 16 to 21, and the shunt resistors 25, which form one inverter 14, and wiring for connecting these components with a sealing body such as resin.

The other power module 41 is constructed by the switching elements and the like, which form the other inverter 15, with a sealing body such as resin. The power module 40 is substantially the same as the power module 41.

The power circuit board 42 is fixed to the heat sink 44 at a side opposite to the motor unit 2. The power circuit board 42 is mounted with the first capacitor 12, the choke coil 13, and the second capacitor 22, which construct the power circuit 11 described above. The second capacitor 22 is interposed between the two side wall parts 46 and 47. The power circuit board 42 is provided with wirings which can pass the current supplied from the power source 100 of the vehicle via the electric connector 60 through the coils 84 of the motor unit 2 via the switching elements 16 to 21 and the second capacitor 22 which are included by the two power modules 40 and 41.

The control circuit board 43 is fixed to a motor side of the heat sink 44. The control circuit board 43 is mounted with the custom IC 31, the rotation angle sensor 32, the microcomputer 33, and the pre-drivers 34 and 35, which construct the control circuit 30. In this way, the control circuit board 43 has the control circuit 30 constructed thereon. The control circuit 30 controls a switching operation of turning on and off the switching elements 16 to 21 of the two power modules 40 and 41 based on signals supplied to the electric connector 60 and the like.

The electric connector 60 and the component carrier 61 are integrally formed of resin such as PBT and are provided at a side opposite to the output part 10 when viewed from the heat sink 44. The electric connector 60 is constructed of a power connector 62, a sensor connector 63, and a signal connector 64. To a power source terminal 621 of the power connector 62 is supplied current for driving the motor 80. To signal terminals 631 of the sensor connector 63 are supplied signals of the torque sensor 9 and the like. To signal terminals 641 of the signal connector 64 are supplied signals of CAN and the like.

In the case where the electric connector 60 and the power modules 40 and 41 are projected to an imaginary plane perpendicular to the motor shaft 83, a part or all of the power connector 62, the sensor connector 63, and the signal connector 64 are positioned between the power modules 40 and 41.

The component carrier 61 has a plate 65, which is nearly shaped like a rectangle and is extended nearly perpendicularly to the motor shaft 83 of the motor 80, and four legs 66 which are extended to the heat sink 44 side from corner portions of the rectangle of the plate 65. Bolts 67 are inserted into holes formed in the axial direction of the legs 66. The bolts 67 are passed through the holes formed in the axial direction of the heat sink 44 and are screwed in female threads formed in the rear end frame 93. In this way, the component carrier 61, the heat sink 44, and the rear end frame 93 are fixed one another.

The cover 70 is formed in the shape of a cylinder having a closed bottom and houses the heat sink 44, the control circuit board 43, the power circuit board 42, and the component carrier 61. The cover 70 is fixed to the rear end frame 93 by screws 71.

The cover 70 has a hole 72, through which the electric connector 60 is passed, formed on a side opposite to the output part 10. The electric connector 60 is passed through the hole 72 from inside of the cover 70 and is extended to the side opposite to the output part 10.

A sealing member 73 is disposed between the plate 65 of the component carrier 61 and the cover 70 in such a way as to surround a radial outside of the hole 72 of the cover 70. In FIG. 6, position in which the sealing member 73 is disposed is shown by a broken line and a solid line. The sealing member 73 is a liquid gasket such as FIPG (formed in place gasket). The sealing member 73 is applied in a liquid state on the plate 65 of the component carrier 61 or on an inner wall of the cover 70 before the cover 70 is fixed to the rear end frame 93. Then, when the cover 70 is fixed to the component carrier 61 by the screws 71, the sealing member 73 is put into close contact between the cover 70 and the component carrier 61.

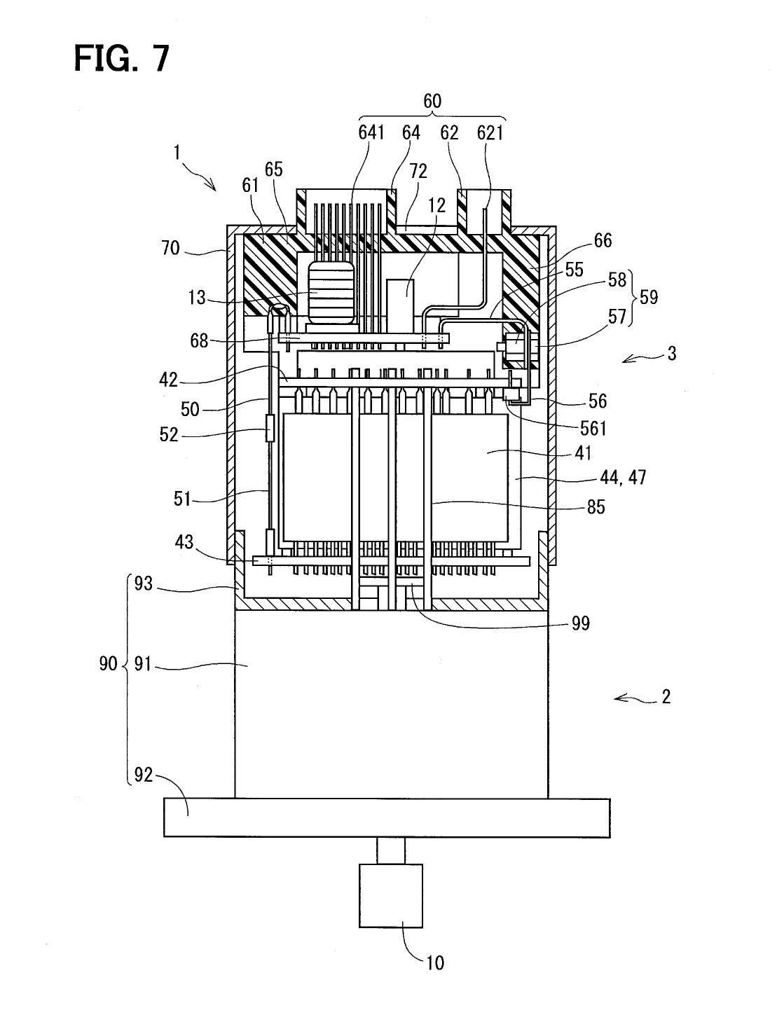

The component carrier 61 is provided with a connector board 68. In this regard, the choke coil 13 and the first capacitor 12 may be fixed to the power circuit board 42 or the component carrier 61 or may be mounted on the connector board 68 as shown in FIG. 7.

The connector board 68 has the power source terminal 621 of the power connector 62, signal terminals 631 of the sensor connector 63, and signal terminals 641 of the signal connector 64 connected thereto. The connector board 68 is a multilayer board in which wiring connected to the power source terminal 621 and the signal terminals 631, 641 are laminated. The wirings connected to the signal terminals 631, 641 or to the power source terminal 621 are laid on the connector board 68 and are arranged at a position, at which a signal wiring 50 or a connection terminal 55 is suitably connected.

The signal wiring 50 electrically connects a control circuit of the control circuit board 43 to the connector board 68. When viewed from a direction of the motor shaft 83 of the motor 80, the signal wiring 50 is positioned in a direction perpendicular to a direction in which the one power module 40 is opposed to the other power module 41.

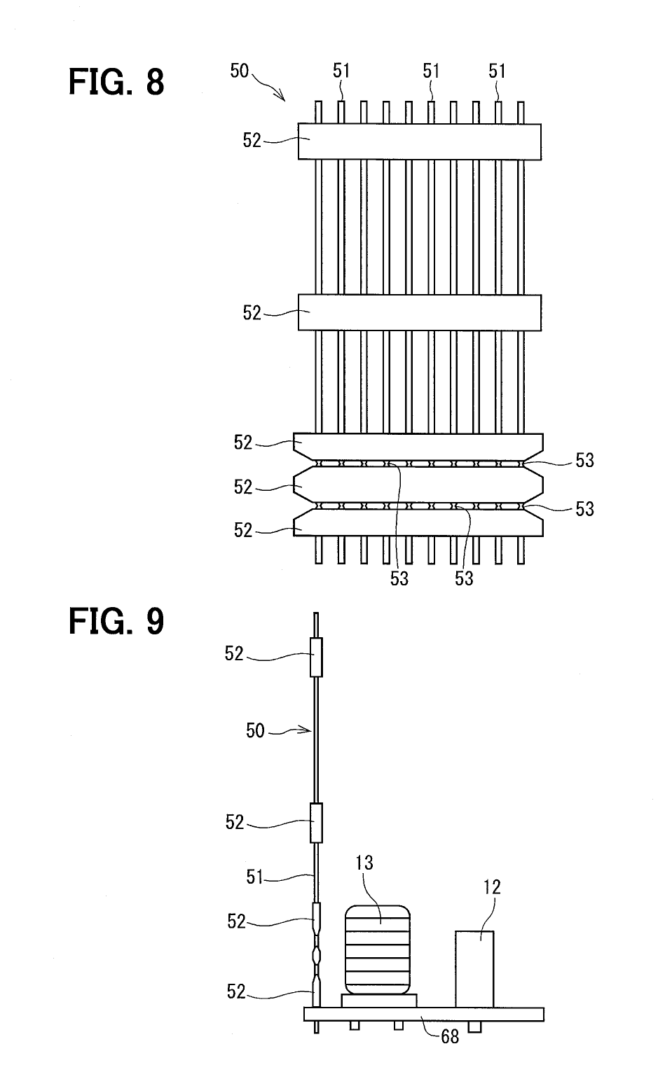

In FIG. 8 is shown the signal wiring 50, which is not yet fixed to the electronic control unit 3.

The signal wiring 50 has a plurality of terminals 51 arranged in parallel and resin molds 52 for integrally molding the plurality of terminals 51. Each of the resin molds 52 extends perpendicularly to the terminals 51 and molds the plurality of terminals 51 in such a way that the plurality of terminals 51 except for bent portions, in which the plurality of terminals 51 are o be bent, are integrated with each other. The plurality of terminals 51 has cutout portions 53, in which bent portions are small in thickness to be bent with less force.

As shown in FIG. 7, the power source terminal 621 of the power connector 62 is mounted on the connector board 68. Further, the power circuit board 42 has the connection terminal 55 mounted thereon. The connection terminal 55 is electrically connected to the power source terminal 621 via the choke coil 13 and the first capacitor 12. The connection terminal 55 has an end portion on a side opposite to the power circuit board 42 molded by the component carrier 61.

On the other hand, the power circuit board 42 has two power wirings 56 mounted thereon, the two power wirings 56 corresponding to the power source 100 and the ground. The two power wirings 56 are integrally molded with resin 561. The connection terminal 55 and the power wirings 56 have holes (not shown) formed therein. When a bolt 57 is inserted into the holes of the connection terminal 55 and the power wirings 56 and a nut 58 is screwed on the bolt 57, the connection terminal 55 is electrically connected to the power wirings 56. A connection portion 59, in which the connection terminal 55 is connected to the power wirings 56, is supported by the component carrier 61. In this way, the bolt 57 can be easily screwed with the nut 58, that is, the connection terminal 55 can be easily connected to the power wirings 56. Here, the connection terminal 55 may be connected to the power wirings 56 by welding.

Next, a method for fixing the signal wiring 50 in relation to a method for manufacturing the motor drive apparatus 1 will be described with reference to FIG. 9 to FIG. 11. The method for fixing the signal wiring 50 includes a first mounting step, a bending step, and a second mounting step.

As shown in FIG. 9, in the first mounting step, one ends of the terminals 51 of the signal wiring 50, leads of the choke coil 13, and leads of the first capacitors 12 are inserted into through holes of the connector board 68 from one direction. The signal wiring 50 has the plurality of terminals 51, which is arranged in parallel and integrally molded with the resin molds 52 so that the signal wiring 50 is raised perpendicularly generally perpendicularly with respect to the connector board 68.

Here, at this time, the power source terminal 621 of the power connector 62, the signal terminals 631 of the sensor connector 63 and the signal terminals 641 of the signal connector 64 may be inserted into through holes of the connector board 68 from the same direction as the signal wiring 50.

Subsequently, the terminals 51 of the signal wiring 50, the leads of the choke coil 13, and the leads of the first capacitor 12 are soldered to the connector board 68 from one direction. That is, they are soldered from a direction opposite to a direction, in which the terminals 51 of the signal wiring 50 are inserted.

In this way, the signal wiring 50, the choke coil 13, and the first capacitor 12 are mounted on the connector board 68 by one step. Here, the signal wiring 50 is raised perpendicularly on a side opposite to a face of the connector board 68, to which these components are soldered, and hence does not interfere with a soldering operation.

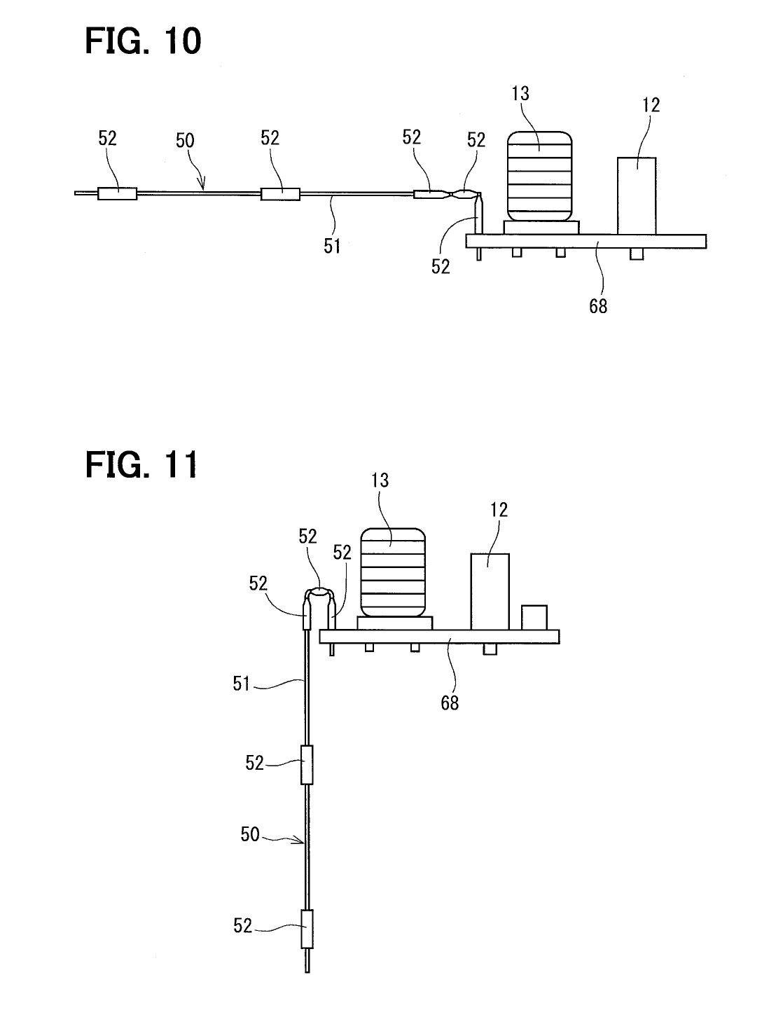

Next, as shown in FIG. 10, in the bending step, the terminals 51 of the signal wiring 50 are bent about 90 degrees in a direction to be parallel to the connector board 68 between a first predetermined resin mold 52 and a second predetermined resin mold 52, which is adjacent to the first predetermined resin mold 52.

Next, as shown in FIG. 11, the terminals 51 of the signal wiring 50 are further bent about 90 degrees in a direction perpendicular to the connector board 68 between the second predetermined resin mold 52 and a third predetermined resin mold 52, which is adjacent to the second predetermined resin mold 52.

Finally, as shown in FIG. 7, in the second mounting step, the other ends of the terminals 51 of the signal wiring 50 are inserted in the through holes of the control circuit board 43 and then are mounted on the control circuit board 43 by soldering. In this way, the signal wiring 50 electrically connects the control circuit 30 of the control circuit board 43 to the connector board 68.

The present embodiment provides the following functions and advantages.

(1) The electronic control unit 3 of the motor drive apparatus 1 is provided with the electric connector 60, which is passed through the hole 72 of the cover 70 from the component carrier 61 and extended to the side opposite to the output part 10 in the axial direction of the motor shaft 83. In this way, even if a space, in which the motor drive apparatus 1 is set, is limited in the radial direction of the motor shaft 83, the electric connector 60 of the motor drive apparatus 1 can be easily connected to the external connector of the vehicle in the axial direction of the motor 80. Hence, the mounting operation of the motor drive apparatus 1 in the vehicle can be enhanced.

(2) The sealing member 73 made of the liquid gasket such as FIPG is disposed between the component carrier 61 and the cover 70 in such a way as to surround the electric connector 60. This can prevent water or a foreign matter from coming into the case from a clearance between the component carrier 61 and the cover 70. Hence, the motor drive apparatus 1 can be easily fixed in an engine compartment of the vehicle.

(3) In the case where the power modules 40 and 41, which include the switching elements 16 to 21, and the electric connector 60 are projected to an imaginary plane perpendicular to the motor shaft 83, a part or all of the electric connector 60 is positioned between the power modules 40 and 41. That is, the electric connector 60 is positioned partly or fully between the power modules 40 and 41. This can increase a region, in which the sealing member 73 is applied to the component carrier 61 around the electric connector 60. Hence, the motor drive apparatus 1 can have high waterproof performance and dust resistance.

(4) The connector board 68 is electrically connected to the signal terminals 631, 641 of the electric connector 60 and to the signal wiring 50. By using the connector board 68, the wiring for connecting the signal terminals 631 and 641 to the signal wiring 50 can be laid in the connector board 68. Hence, the manufacturing cost of the motor drive apparatus 1 can be reduced and the size of the motor drive apparatus 1 can be reduced.

(5) When viewed in the direction of the motor shaft 83, the signal wiring 50 is positioned in a direction perpendicular to a direction, in which one power module 40 is opposed to the other power module 41. This can increase the distance between the signal wiring 50 and the power modules 40 and 41 and hence can reduce the influence that the electromagnetic wave generated by the large current passing through the power modules 40 and 41 produces on the signal wiring 50.

(6) The signal wiring 50 has one end inserted into the through hole of the connector board 68 from the connector 60 side and is mounted on the connector board 68 in a state, in which the signal wiring 50 is raised perpendicularly with respect to the connector board 68. Thereafter, the signal wiring 50 is bent to the control circuit board 43 side and hence is extended parallel to the motor shaft 83 and has the other end mounted on the control circuit board 43. In this way, the signal terminals 631, 641 of the electric connector 60 and the signal wiring 50 can be mounted on the connector board 68 from the same direction. For this reason, the signal terminals 631, 641 of the electric connector 60 and the signal wiring 50 can be soldered to the connector board 68 by one step. Further, the signal wiring 50 is raised perpendicularly from the connector board 68 at a side opposite to a face, to which those components are soldered, and hence does not interfere with the soldering operation.

(7) The signal wiring 50 has the plurality of terminals 51 and the resin molds 52 for integrally molding the plurality of terminals 51 except for portions in which the plurality of terminals 51 are bent. In this way, the plurality of terminals 51 can be fixed to the connector board 68 or the control circuit board 43 at one time. Further, the plurality of terminals 51 can be bent at a time after the signal wiring 50 is mounted on the connector board 68. Hence, the workability of fixing the signal wiring 50 can be improved.

(8) The plurality of terminals 51 have cutout portions 53, in which bent portions have less thickness than other straight portions. In this way, the plurality of terminals 51 can be easily bent at a predetermined position.

### Second Embodiment

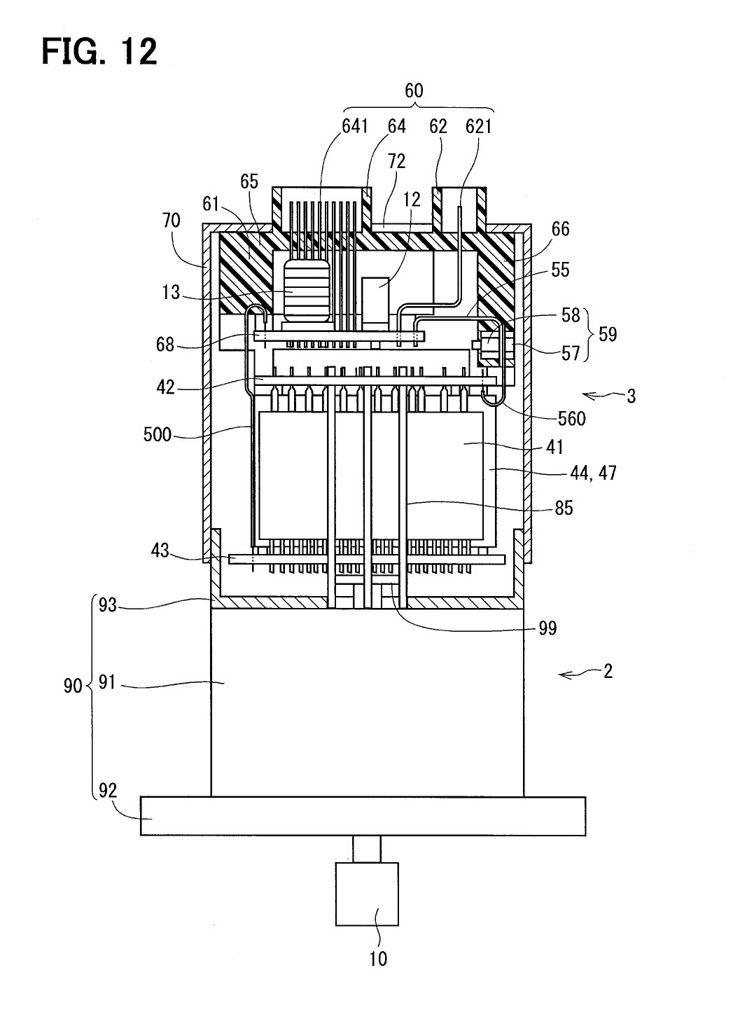

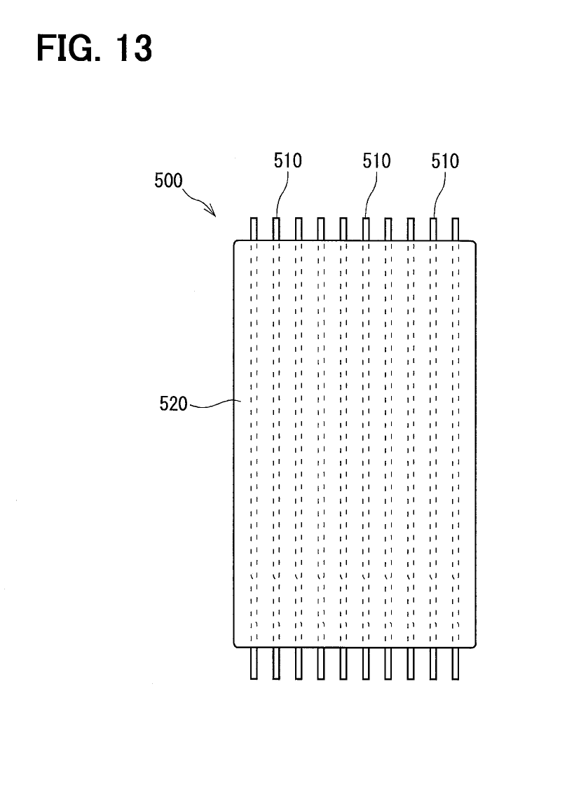

A motor drive apparatus according to a second embodiment is shown in FIG. 12 and FIG. 13. In the second embodiment, the substantially same constructions as in the first embodiment are denoted by the same reference signs and their descriptions will be omitted.

In the second embodiment, a signal wiring 500 is formed in a flexible flat wire set. In FIG. 13 is shown a flexible flat wire set before being fixed to the electronic control unit 3. The flexible flat wire set is made by covering a plurality of plate-shaped conducting bodies 510 with an insulating body 520 such as paper. As shown in FIG. 12, the signal wiring 500 has one end mounted on the connector board 68 from a connector side and bent to a control circuit board side and has the other end mounted on the control circuit board 43. The signal wiring 500 electrically connects the control circuit 30 of the control circuit board 43 to the connector board 68.

Further, a power wiring 560 for connecting the connection terminal 55 mounted on the connector board 68 to the power circuit board 42 is also formed in a flexible flat wire set.

The flexible flat wire sets are used for the signal wiring 500 and the power wiring 560 and hence the signal wiring 500 can be easily arranged. Hence, the workability of fixing the signal wiring 500 and the power wiring 560 can be improved and hence man-hours required to assemble the electronic control unit 3 can be reduced.

### Other Embodiments

In the embodiments described above, the motor drive apparatus is exemplified as being fixed in parallel to the shaft of the rack of the vehicle. However, the motor drive apparatus may be fixed to a column shaft of the vehicle. The motor drive apparatus is not limited to the embodiments described above, but may be implemented differently.

What is claimed is:

1. A motor drive apparatus comprising:
a motor having a motor shaft;
a motor case for housing the motor;
an output part protruded from the motor case in one direction of the motor shaft for outputting torque of the motor;
a heat sink disposed on a side axially opposite to the output part of the motor case;
a connector disposed on a side axially opposite to the output part relative to the heat sink and provided with a power source terminal, which supplies a current for driving the motor, and signal terminals, which supplies signals for controlling drive of the motor;
a component carrier formed integrally with the connector and fixed to the heat sink;
a plurality of switching elements fixed to the heat sink and for converting the current supplied to the power source terminal of the connector into a current for driving the motor;
a power circuit board disposed on the heat sink at a side opposite to the output part and provided with a wiring, through which the current for driving the motor is passed from the power source terminal of the connector via the switching elements;
a control circuit board disposed on the heat sink at an output part side and provided with a control circuit for controlling operations of the switching elements based on signals supplied to the signal terminals of the connector; and
a cover housing the heat sink, the component carrier, the switching elements, the control circuit board and the power circuit board, and having a hole through which the connector is passed at a side opposite to the output part,
wherein the connector is extended from the component carrier to pass through the hole of the cover to an outside of the cover at a side opposite to the output part.

2. The motor drive apparatus according to claim 1, further comprising:
a sealing member that surrounds the connector and is interposed between the component carrier and the cover.

3. The motor drive apparatus according to claim 2, wherein:
the heat sink has a plurality of side wall parts arranged symmetrically with respect to an axis of the motor shaft of the motor;
the plurality of switching elements are fixed to the plurality of side wall parts; and
the connector is positioned partially or entirely between a part of the switching elements and other part of the switching elements, in a case where the connector and the switching elements are projected to an imaginary plane perpendicular to the motor shaft of the motor.

4. The motor drive apparatus according to claim 1, further comprising:
a connector board disposed on the component carrier at a control circuit board side and electrically connected to the signal terminals of the connector; and
a signal wiring for electrically connecting the control circuit of the control circuit board to the connector board.

5. The motor drive apparatus according to claim 4, wherein:
the signal wiring has one end mounted on the connector board from a connector side and has other end mounted on the control circuit board, the signal wiring being bent to extend toward the control circuit board side in parallel to the axis of the motor shaft between the one end and the other end.

6. The motor drive apparatus according to claim 4, wherein:
the signal wiring is positioned in a direction perpendicular to a direction, in which a part of the switching elements and other part of the switching elements face, when viewed in a direction of the motor shaft.

7. The motor drive apparatus according to claim 4, wherein:
the signal wiring has a plurality of terminals and a resin mold for integrally molding the plurality of terminals except for a bent portion, at which the plurality of terminals are bent.

8. The motor drive apparatus according to claim 7, wherein:
the plurality of terminals has a cutout portion, in which the bent portion is small in thickness.

9. The motor drive apparatus according to claim 4, wherein:
the signal wiring is formed in a flexible flat wire set.

10. The motor drive apparatus according to claim 1, further comprising:
a connection terminal electrically connected to the power source terminal of the connector;
a power wiring extended from the power circuit board; and
a connection part for connecting the connection terminal to the power wiring,
wherein the connection part is supported by the component carrier.

11. The motor drive apparatus according to claim 2, further comprising:
a connector board disposed on the component carrier at a control circuit board side and electrically connected to the signal terminals of the connector; and
a signal wiring for electrically connecting the control circuit of the control circuit board to the connector board.

12. The motor drive apparatus according to claim 3, further comprising:
a connector board disposed on the component carrier at a control circuit board side and electrically connected to the signal terminals of the connector; and
a signal wiring for electrically connecting the control circuit of the control circuit board to the connector board.

13. The motor drive apparatus according to claim 2, further comprising:
a connection terminal electrically connected to the power source terminal of the connector;
a power wiring extended from the power circuit board; and
a connection part for connecting the connection terminal to the power wiring,
wherein the connection part is supported by the component carrier.

14. The motor drive apparatus according to claim 3, further comprising:
a connection terminal electrically connected to the power source terminal of the connector;
a power wiring extended from the power circuit board; and
a connection part for connecting the connection terminal to the power wiring,
wherein the connection part is supported by the component carrier.

15. A method for manufacturing the motor drive apparatus according to claim 4, the method comprising:
a first mounting step of inserting one end of the signal wiring into the connector board from a connector side and soldering the signal wiring to the connector board in a state where the signal wiring is raised perpendicularly with respect to the connector board;
a bending step of bending the signal wiring toward the control circuit board; and
a second mounting step of mounting other end of the signal wiring on the control circuit board.
